(19) United States
(12) Patent Application Publication
(10) Pub. No.: US 2009/0305914 A1
(43) Pub. Date: Dec. 10, 2009

(54) Phosphorus-Free Gelled Hydrocarbon Compositions and Method for Use Thereof

(76) Inventors: Leiming Li, Sugar Land, TX (US); Syed Ali, Sugar Land, TX (US); Lijun Lin, Sugar Land, TX (US); Mathew M. Samuel, Sugar Land, TX (US); Curtis L. Boney, Houston, TX (US); Francois M. Auzerais, Boston, MA (US); Richard Marcinew, Calgary (CA); Paul R. Howard, Sugar Land, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/433,076

(22) Filed: Apr. 30, 2009

Related U.S. Application Data
(60) Provisional application No. 61/051,060, filed on May 7, 2008.

(51) Int. Cl. C09K 8/64

(52) U.S. Cl. 507/265

(57) ABSTRACT

A method of forming a gelled organic-based fluid is disclosed. The method comprises combining an organic solvent, a viscoelastic surfactant, and a metal carboxylate crosslinker; and forming the gelled organic-based fluid. In a further aspect, the method is used to treat a subterranean formation of a well, for example for a stimulation job as fracturing or the like.

### RELATED APPLICATIONS

The present application claims the benefit of U.S. Provisional Patent Application No. 61/051,060 filed May 7, 2008, entitled Phosphorus-free gelled hydrocarbon compositions and method for use thereof, which is hereby incorporated by reference.

### FIELD OF THE INVENTION

This invention relates to compositions and methods for treating subterranean formations penetrated by well bores. More particularly, the invention relates to additives for gelling of hydrocarbon fluids and most particularly, to non-phosphorus gellants for use in hydraulic fracturing fluids.

### BACKGROUND

The statements in this section merely provide background information related to the present disclosure and may not constitute prior art.

Gelled liquid hydrocarbon fluids have been utilized in a variety of treatments for subterranean formations penetrated by well bores, including stimulation activities such as fracturing and/or gravel packing. Such hydrocarbon fluids must have a sufficiently high viscosity to generate a fracture of sufficient dimensions and also to carry the proppant particles to the wellbore and to the fracture.

Formation sensitivity to water is a primary consideration for selection of oil-based fracturing fluids. They are commonly used in formations which are known to be extremely water-sensitive or suffer permeability reduction when exposed to aqueous fluids.

Aluminum phosphate ester salts are commonly used to viscosify hydrocarbon-based fracturing fluids. These gelled hydrocarbons have the temperature stability and proppant carrying capability expected from the gelled-fluids. However, the use of aluminum phosphate ester systems can contribute to rate limiting fouling (i.e., phosphate scale deposits) in petroleum distillation towers caused by phosphate esters used in gelled-hydrocarbon fracturing fluids.

### SUMMARY OF THE INVENTION

Disclosed are gelled hydrocarbon fluids formed from a mixture of at least a hydrocarbon (e.g. diesel, kerosene, mineral spirits and crude oils), a gelling agent including a viscoelastic surfactant, such as zwitterionic surfactant (e.g., erucic amidopropyl dimethyl betaine), and a metal carboxylate crosslinker (e.g., aluminum octoate). Methods of using such fluids are disclosed as well. In some embodiments, no fatty acid is included with the VES component.

A method of forming a gelled organic-based fluid is disclosed. The method comprises combining an organic solvent, a viscoelastic surfactant, and a metal carboxylate crosslinker; and forming the gelled organic-based fluid.

In an embodiment, the organic solvent is selected from the group consisting of diesel oil, kerosene, paraffinic oil, crude oil, refined oil, gas-condensates, LPG, toluene, xylene, ether, ester, mineral oil, biodiesel, vegetable oil, animal oil, alcohol, and mixtures thereof.

In an embodiment, the viscoelastic surfactant comprises a betaine compound selected from the group consisting of erucic amidopropyl dimethyl betaine, oleoylamidopropyl dimethyl betaine, cocamidopropyl betaine, and mixtures thereof. The carboxylic acids are preferably branched, and each carboxylic branch has from about 6 to about 30 carbon atoms. In a first embodiment, the metal carboxylate crosslinker is selected from the group consisting of: di-ester with the same branched carboxylic acid, tri-ester with the same branched carboxylic acid and mixtures thereof. The metal carboxylate crosslinker may be an aluminum carboxylate crosslinker. In this embodiment, the aluminum carboxylate crosslinker is selected from group consisting of aluminum 2-ethylhexanoate, hydroxyaluminum bis(2-ethylhexanoate), and mixtures thereof. In a second embodiment, the metal carboxylate crosslinker is a di-ester or a tri-ester made with different branched carboxylic acids.

The gelled organic-based fluid may further comprise a breaker, e.g ammonium bicarbonate. The gelled organic-based fluid may be foamed.

In an embodiment, forming the gelled organic-based fluid does not comprise addition of a phosphorus source. Phosphorus can be present in traces or naturally in other components used. However no intentional addition of phosphorus is made. Also in another embodiment, forming the gelled organic-based fluid does not comprise addition of a fatty acid i.e. an aliphatic monocarboxylic acid.

The method of forming the gel can be used as a method of accelerating gelled-hydrocarbon viscosity development, i.e. where continuous-mixing processes are preferred, irrespective of application.

In another aspect, a method of treating a subterranean formation from a well is disclosed. The method comprises providing an organic solvent, a viscoelastic surfactant, and a metal carboxylate crosslinker; combining the organic solvent, the viscoelastic surfactant and the metal carboxylate crosslinker to form a gelled organic-based fluid; introducing the gelled organic-based fluid in to the well; and allowing the gelled organic-based fluid to contact the formation.

In an embodiment, the method is fracturing, and introducing the gelled organic-based fluid in to the well is done at a pressure above a fracturing pressure of the subterranean formation. The method may further comprise introducing proppant in to the well.

In an embodiment, treating the subterranean formation with the gelled organic-based fluid does not comprise providing a phosphorus source for treating the subterranean formation. Phosphorus can be present in traces or naturally in other components used. However no intentional addition of phosphorus is made. Still in an embodiment, forming the gelled organic-based fluid is done without addition of a fatty acid i.e. an aliphatic monocarboxylic acid.

In an embodiment, the organic solvent is selected from the group consisting of diesel oil, kerosene, paraffinic oil, crude oil, refined oil, gas-condensates, LPG, toluene, xylene, ether, ester, mineral oil, biodiesel, vegetable oil, animal oil, alcohol, and mixtures thereof.

In an embodiment, the viscoelastic surfactant comprises a betaine compound selected from the group consisting of erucic amidopropyl dimethyl betaine, oleoylamidopropyl dimethyl betaine, cocamidopropyl betaine, and mixtures thereof. The gelled organic-based fluid may further comprise a breaker, e.g ammonium bicarbonate.

The carboxylic acids are preferably branched, and each carboxylic branch has from about 6 to about 30 carbon atoms. In a first embodiment, the metal carboxylate crosslinker is selected from the group consisting of: di-ester with the same branched carboxylic acid, tri-ester with the same branched carboxylic acid and mixtures thereof. The metal carboxylate crosslinker may be an aluminum carboxylate crosslinker. In this embodiment, the aluminum carboxylate crosslinker is selected from group consisting of aluminum 2-ethylhexanoate, hydroxyaluminum bis(2-ethylhexanoate), and mixtures thereof. In a second embodiment, the metal carboxylate crosslinker is a di-ester or a tri-ester made with different branched carboxylic acids.

Still in another aspect, a gelled organic-based fluid for use within a well, is disclosed, the fluid comprises an organic solvent, a viscoelastic surfactant, and a metal carboxylate crosslinker. The carboxylic acids are preferably branched, and each carboxylic branch has from about 6 to about 30 carbon atoms. In a first embodiment, the metal carboxylate crosslinker is selected from the group consisting of: di-ester with the same branched carboxylic acid, tri-ester with the same branched carboxylic acid and mixtures thereof. The metal carboxylate crosslinker may be an aluminum carboxylate crosslinker. In this embodiment, the aluminum carboxylate crosslinker is selected from group consisting of aluminum 2-ethylhexanoate, hydroxyaluminum bis(2-ethylhexanoate), and mixtures thereof. In a second embodiment, the metal carboxylate crosslinker is a di-ester or a tri-ester made with different branched carboxylic acids.

In an embodiment, the organic solvent is selected from the group consisting of diesel oil, kerosene, paraffinic oil, crude oil, refined oil, gas-condensates, LPG, toluene, xylene, ether, ester, mineral oil, biodiesel, vegetable oil, animal oil, alcohol, and mixtures thereof.

In an embodiment, the viscoelastic surfactant comprises a betaine compound selected from the group consisting of erucic amidopropyl dimethyl betaine, oleoylamidopropyl dimethyl betaine, cocamidopropyl betaine, and mixtures thereof. The gelled organic-based fluid may further comprise a breaker, e.g ammonium bicarbonate.

Still in another aspect a method of treating a well or a pipeline is disclosed, the method comprises: providing an organic solvent, a viscoelastic surfactant, and a metal carboxylate crosslinker; combining the organic solvent, the viscoelastic surfactant and the metal carboxylate crosslinker to form a gelled organic-based fluid; and introducing the gelled organic-based fluid in to the well.

In an embodiment, the step of treating the well is selected from the group consisting of: cleanout of the well, cleanout of the pipeline, scale removal of the well, scale removal of the pipeline, solid removal of the well, solid removal of the pipeline, assisting solid transport of the well, assisting solid transport of the pipeline, assisting paraffin transport of the well, assisting paraffin transport of the pipeline, assisting asphaltene transport of the well, assisting asphaltene transport of the pipeline, fluid loss control of the well, fluid diversion of the well, and combinations thereof. The treating can be done with a coil tubing. Treating is preferably done without use of proppant.

Down-hole well applications include fracturing, sand-control, solids cleanout/transport, scale removal, chemical/viscous diversion, oilbase mud spacer/removal. Surface applications (on a pipeline) include pipeline pigging (formerly YFGO “jelly-pig”, where solid-core or foam plugs were not practical) for solids/paraffin/asphaltene transport and removal within pipelines.

In an embodiment, the organic solvent is selected from the group consisting of diesel oil, kerosene, paraffinic oil, crude oil, refined oil, gas-condensates, LPG, toluene, xylene, ether, ester, mineral oil, biodiesel, vegetable oil, animal oil, alcohol, and mixtures thereof.

In an embodiment, the viscoelastic surfactant comprises a betaine compound selected from the group consisting of erucic amidopropyl dimethyl betaine, oleoylamidopropyl dimethyl betaine, cocamidopropyl betaine, and mixtures thereof.

The carboxylic acids are preferably branched, and each carboxylic branch has from about 6 to about 30 carbon atoms. In a first embodiment, the metal carboxylate crosslinker is selected from the group consisting of: di-ester with the same branched carboxylic acid, tri-ester with the same branched carboxylic acid and mixtures thereof. The metal carboxylate crosslinker may be an aluminum carboxylate crosslinker. In this embodiment, the aluminum carboxylate crosslinker is selected from group consisting of aluminum 2-ethylhexanoate, hydroxyaluminum bis(2-ethylhexanoate), and mixtures thereof. In a second embodiment, the metal carboxylate crosslinker is a di-ester or a tri-ester made with different branched carboxylic acids.

The gelled organic-based fluid may further comprise a breaker, e.g ammonium bicarbonate. The gelled organic-based fluid may be foamed.

In an embodiment, forming the gelled organic-based fluid does not comprise addition of a phosphorus source. Phosphorus can be present in traces or naturally in other components used. However no intentional addition of phosphorus is made. Also in another embodiment, forming the gelled organic-based fluid does not comprise addition of a fatty acid i.e. an aliphatic monocarboxylic acid.

### BRIEF DESCRIPTION OF THE DRAWINGS

FIG. 1 shows viscosity profile at 100 deg C. for two gelled oil samples made up of: (1) diesel, 6% VES, 0.4% aluminum triisopropanolate, and 2.4% aluminum 2-ethylhexanoate; and (2) diesel, 6% VES, and 2.4% aluminum 2-ethylhexanoate.

FIG. 2 shows viscosity profile at 82 deg C. for the gelled oil formulation consisting of diesel, 3% VES, and 1.2% aluminum 2-ethylhexanoate.

FIG. 3 shows viscosity profile at 100 deg C. for two gelled oil formulations consisting of: (1) diesel, 3% VES, and 2.4% aluminum 2-ethylhexanoate; and (2) diesel, 3% VES, 2.4% aluminum 2-ethylhexanoate, and 0.6% ammonium bicarbonate (NH₄HCO₃) breaker.

FIG. 4 shows viscosity profile at 100 deg C. for the gelled oil formulation consisting of diesel, 3% VES containing erucic amidopropyl dimethyl betaine, and 2.4% hydroxyaluminum bis(2-ethylhexanoate).

FIG. 5 shows viscosity profile at 100 deg C. for the gelled oil formulation consisting of diesel, 3% VES containing oleoylamidopropyl dimethyl betaine, and 1.9% aluminum 2-ethylhexanoate.

### DETAILED DESCRIPTION

At the outset, it should be noted that in the development of any actual embodiments, numerous implementation-specific decisions must be made to achieve the developer's specific goals, such as compliance with system- and business-related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

Fluids and methods using fluids are based upon at least one organic base, such as a hydrocarbon fluid. As used herein, “organic solvent” includes, for example, any organic fluid medium suitable to facilitate ease of reaction and/or intermixing of the disclosed reactants, ease of handling of the disclosed reactants or resulting reaction products, and/or that may be optionally selected to be removable (e.g. by distillation) from a reaction product, following reaction. Organic solvents may be selected to have desired properties relative to the given reactants employed and may be chosen, for example, from any of the hydrocarbon or other organic fluids listed elsewhere herein as suitable for organic base fluids. When used, the hydrocarbon fluid comprises any known hydrocarbon liquid such as crude oil, refined or partially refined oil, fuel oil, liquefied gas, alkanes, alpha-olefins, internal olefins, diesel oil, condensates and combinations of hydrocarbons. In an embodiment the organic solvent is diesel. In other embodiments, diesel can be replaced with a number of other hydrocarbons and solvents: xylene, LPG, toluene, ether, ester, mineral oil, other petroleum distillates, vegetable oil, animal oil, bio-diesel, etc. As used herein, “fatty acid” is a carboxylic acid often with a long unbranched aliphatic tail chain. Fatty acids are aliphatic monocarboxylic acids derived from or contained in esterified form in an animal or vegetable fat, oil or wax. Aliphatics include alkanes (e.g. paraffin hydrocarbons), alkenes (e.g. ethylene) and alkynes (e.g. acetylene). Natural fatty acids commonly have a chain of 4 to 28 carbons (usually unbranched and even-numbered), which may be saturated or unsaturated.

The gelling agents used as crosslinker according to the present invention are salts of carboxylic acids having from about 6 to about 30 carbon atoms, and preferably from about 8 to about 20 carbon atoms.

These gelling agents may be prepared by heating the carboxylic acid with a multivalent metal compound. These metals are preferably divalent or trivalent, and may be complexed with anions including halides, hydroxides, sulfates, sulfonates, nitrates, carboxylates, and other oxo anions, and so forth. Preferably, this is accomplished in a ratio of about two or three carboxylic acid equivalents to one metal, and preferably, the salts formed are di- and tri-salts having the following general formula:

(CH₃—(CH₂)_{y}—COO)ₙX

wherein y is 6 to 28, and preferably 6 to 18; n is 2 or 3; and X is a multivalent metal such as aluminum, boron, zinc, copper, iron, magnesium, calcium, barium, titanium, zirconium, tin, cobalt and so forth, and mixtures thereof, or a metal alkoxide, complexed to carboxylic acid groups. Aluminum is one of the preferred multivalent metals for use in the present invention. Most preferably, the resultant salts are tri-salts having three carboxylic acid groups complexed to one metal, or the structure is a metal covalently bonded to an alkoxide group and two carboxylic acid groups.

Specific aluminum compounds useful herein include aluminum acetate, aluminum alkoxides including isopropoxide, aluminum sulfate, aluminum chloride, aluminum hydroxide and poly-oxo-aluminum compounds.

The carboxylic acids are preferably branched, and have from about 6 to about 30 carbon atoms. A preferable branched carboxylic acid for use herein is 2-ethylhexanoic acid. Linear carboxylic acids may also be utilized in combination with the branched carboxylic acids of the present invention, a preferable linear carboxylic acid being octanoic acid.

In a first embodiment, the gelling agent is a di-ester or a tri-ester made with the same branched carboxylic acid. In this way, in a planar representation, the organometallic salt is symmetrical. In a particular embodiment, the gelling agent is hydroxyaluminium bis(2-ethylhexanoate) or aluminum 2-ethylhexanoate, or a combination of both. In a second embodiment, the gelling agent is a di-ester or a tri-ester made with different branched carboxylic acids.

The linear carboxylic acids are combined with a viscoelastic surfactant to gel sufficiently, or to have a sufficient increase in viscosity. The resultant combination is liquid. The fluid may also contain in another embodiment gel stabilizers, including but not limited to a source of basic aluminum such as sodium aluminate, aluminum alkoxides or aluminum acetate to assist in formation of the gel structure.

The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which is incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

Non-limiting examples of suitable viscoelastic surfactants useful for viscosifying some fluids include cationic surfactants, anionic surfactants, zwitterionic surfactants, amphoteric surfactants, nonionic surfactants, and combinations thereof.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to about 10 if m is 0; a′ and b′ are each 1 or 2 when m′ is not 0 and (a′+b′) is from 1 to about 5 if m is 0; (m+m′) is from 0 to about 14; and CH₂CH₂O may also be OCH₂CH₂.

In an embodiment of the invention, a zwitterionic surfactant of the family of betaine is used. Two suitable examples of betaines are BET-O and BET-E. The surfactant in BET-O-30 is shown below; one chemical name is oleylamidopropyl betaine. It is designated BET-O-30 because as obtained from the supplier (Rhodia, Inc. Cranbury, N.J., U.S.A.) it is called Mirataine BET-O-30 because it contains an oleyl acid amide group (including a C₁₇H₃₃ alkene tail group) and contains about 30% active surfactant; the remainder is substantially water, sodium chloride, and propylene glycol. An analogous material, BET-E-40, is also available from Rhodia and contains an erucic acid amide group (including a C₂₁H₄₁ alkene tail group) and is approximately 40% active ingredient, with the remainder being substantially water, sodium chloride, and isopropanol. VES systems, in particular BET-E-40, optionally contain about 1% of a condensation product of a naphthalene sulfonic acid, for example sodium polynaphthalene sulfonate, as a rheology modifier, as described in U.S. Patent Application Publication No. 2003-0134751. The surfactant in BET-E-40 is also shown below; one chemical name is erucylamidopropyl betaine. As-received concentrates of BET-E-40 were used in the experiments reported below, where they will be referred to as “VES”. BET surfactants, and other VES's that are suitable for the present invention, are described in U.S. Pat. No. 6,258,859. According to that patent, BET surfactants make viscoelastic gels when in the presence of certain organic acids, organic acid salts, or inorganic salts; in that patent, the inorganic salts were present at a weight concentration up to about 30%. Co-surfactants may be useful in extending the brine tolerance, and to increase the gel strength and to reduce the shear sensitivity of the VES-fluid, in particular for BET-O-type surfactants. An example given in U.S. Pat. No. 6,258,859 is sodium dodecylbenzene sulfonate (SDBS), also shown below. Other suitable co-surfactants include, for example those having the SDBS-like structure in which x=5−15; preferred co-surfactants are those in which x=7−15. Still other suitable co-surfactants for BET-O-30 are certain chelating agents such as trisodium hydroxyethylethylenediamine triacetate. The rheology enhancers of the present invention may be used with viscoelastic surfactant fluid systems that contain such additives as co-surfactants, organic acids, organic acid salts, and/or inorganic salts.

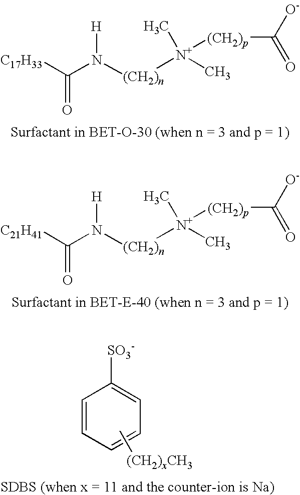

Some embodiments of the present invention use betaines; most preferred use BET-E-40. Although experiments have not been performed, it is believed that mixtures of betaines, especially BET-E-40, with other surfactants are also suitable. Such mixtures are within the scope of embodiments of the invention.

Other betaines that are suitable include those in which the alkene side chain (tail group) contains 17-23 carbon atoms (not counting the carbonyl carbon atom) which may be branched or straight chained and which may be saturated or unsaturated, n=2-10, and p=1-5, and mixtures of these compounds. More preferred betaines are those in which the alkene side chain contains 17-21 carbon atoms (not counting the carbonyl carbon atom) which may be branched or straight chained and which may be saturated or unsaturated, n=3-5, and p=1-3, and mixtures of these compounds. These surfactants are used at a concentration of about 0.5 to about 10%, preferably from about 1 to about 5%, and most preferably from about 1.5 to about 4.5%.

Exemplary cationic viscoelastic surfactants include the amine salts and quaternary amine salts disclosed in U.S. Pat. Nos. 5,979,557, and 6,435,277 which have a common Assignee as the present application and which are hereby incorporated by reference. Examples of suitable cationic viscoelastic surfactants include cationic surfactants having the structure:

R₁N⁺(R₂)(R₃)(R₄)X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Cationic surfactants having the structure R₁N⁺(R₂)(R₃)(R₄)X⁻ may optionally contain amines having the structure R₁N(R₂)(R₃). It is well known that commercially available cationic quaternary amine surfactants often contain the corresponding amines (in which R₁, R₂, and R₃ in the cationic surfactant and in the amine have the same structure). As received commercially available VES surfactant concentrate formulations, for example cationic VES surfactant formulations, may also optionally contain one or more members of the group consisting of alcohols, glycols, organic salts, chelating agents, solvents, mutual solvents, organic acids, organic acid salts, inorganic salts, oligomers, polymers, co-polymers, and mixtures of these members. They may also contain performance enhancers, such as viscosity enhancers, for example polysulfonates, for example polysulfonic acids, as described in U.S. Pat. No. 7,084,095 which is hereby incorporated by reference.

Another suitable cationic VES is erucyl bis(2-hydroxyethyl)methyl ammonium chloride, also known as (Z)-13 docosenyl—N—N-bis(2-hydroxyethyl)methyl ammonium chloride. It is commonly obtained from manufacturers as a mixture containing about 60 weight percent surfactant in a mixture of isopropanol, ethylene glycol, and water. Other suitable amine salts and quaternary amine salts include (either alone or in combination in accordance with the invention), erucyl trimethyl ammonium chloride; N-methyl—N,N-bis(2-hydroxyethyl) rapeseed ammonium chloride; oleyl methyl bis(hydroxyethyl) ammonium chloride; erucylamidopropyltrimethylamine chloride, octadecyl methyl bis(hydroxyethyl) ammonium bromide; octadecyl tris(hydroxyethyl) ammonium bromide; octadecyl dimethyl hydroxyethyl ammonium bromide; cetyl dimethyl hydroxyethyl ammonium bromide; cetyl methyl bis(hydroxyethyl) ammonium salicylate; cetyl methyl bis(hydroxyethyl) ammonium 3,4,-dichlorobenzoate; cetyl tris(hydroxyethyl) ammonium iodide; cosyl dimethyl hydroxyethyl ammonium bromide; cosyl methyl bis(hydroxyethyl) ammonium chloride; cosyl tris(hydroxyethyl) ammonium bromide; dicosyl dimethyl hydroxyethyl ammonium bromide; dicosyl methyl bis(hydroxyethyl) ammonium chloride; dicosyl tris(hydroxyethyl) ammonium bromide; hexadecyl ethyl bis(hydroxyethyl) ammonium chloride; hexadecyl isopropyl bis(hydroxyethyl) ammonium iodide; and cetylamino, N-octadecyl pyridinium chloride.

Many fluids made with viscoelastic surfactant systems, for example those containing cationic surfactants having structures similar to that of erucyl bis(2-hydroxyethyl) methyl ammonium chloride, inherently have short re-heal times and the rheology enhancers of the present invention may not be needed except under special circumstances, for example at very low temperature.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Presently preferred alkyl sarcosinates have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

The gel also typically contains proppants. The selection of a proppant involves many compromises imposed by economical and practical considerations. Criteria for selecting the proppant type, size, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated, preferably pre-cured resin coated, provided that the resin and any other chemicals that might be released from the coating or come in contact with the other chemicals of the Invention are compatible with them. Proppants and gravels in the same or different wells or treatments can be the same material and/or the same size as one another and the term “proppant” is intended to include gravel in this discussion. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, preferably from about 0.12 to about 0.72 kg/L, preferably from about 0.12 to about 0.54 kg/L. The fluid may also contain other enhancers or additives.

In some embodiments, the gelled fluid further comprises a breaker selected from the group consisting of oxidative breakers, enzymes, pH modifiers, metal chelators, metal complexors, polymer hydrolysis enhancers, and micelle disturbing substances. Any breaker material suitable for reducing viscosity of the disclosed gels may be employed. Examples include calcined magnesium oxide and tetraethylenepentamine. The breaker may be solid or liquid. The breaker may be encapsulated. The breaker can include delay breaker or impregnated breaker. Examples of alkaline pH modifiers that can be used to cause emulsion destabilization include alkali metal hydroxides, oxides, phosphates, carbonates and bicarbonates; alkaline earth oxides, phosphates, and carbonates; ammonium hydroxide, ammonium carbonate, and ammonium bicarbonate; alkali metal silicates, and base precursors such as ureas and substituted ureas, cyanates, alkylamines and certain alkanolamines, quaternary ammonium salts, ammonium salts and salts of a weak acid and a strong base, among others. In a particular embodiment, the breaker is ammonium bicarbonate.

In some embodiments, the use of partial monoesters of styrene maleic anhydride copolymers and fatty alcohols (“MSMA's”), as disclosed in U.S. Pat. No. 6,849,581, incorporated herein by reference thereto, are not necessary for greatly enhanced rheology performance, but may be useful in some other embodiments. When used, many of such MSMA-based compounds are available in solid resin form and may be first dissolved in an organic solvent (e.g., xylene, toluene, or any solvent capable of dissolution of the MSMA-based compound) in any suitable amount (e.g., from about 1% to about 50%) MSMA-based compound by weight of organic solvent solution. The MSMA-based compound/solvent solution may then be combined in any suitable manner with other components. For example, a metal source, such as aluminum isopropoxide may be directly combined with the MSMA-based compound/solvent solution and heated (if necessary) to form a gelled fluid. Alternatively the MSMA-based compound/solvent solution may be combined with at least one fatty acid and at least one metal source, and heated (if necessary) to form a gelled fluid. In some embodiments, an additional metal source may be “back added” following initial combination of ingredients, if so desired; however, in many embodiments, such additional metal sources are not required.

Methods of use of the fluids of the invention include use in a wellbore for fracturing operations, where the gelled hydrocarbon fluid is pumped in from the mixing tanks and into the well bore at a desired fracturing pressure. The fluid is pumped into the formation fractures, and once the fracturing operation is completed, the pressure is released.

The method of forming the gel can be used as a method of accelerating gelled-hydrocarbon viscosity development, i.e. where continuous-mixing processes are preferred, irrespective of application. Currently aluminum octoate/octanoate systems are used for many other purposes, but require residence time to form a gel structure.

The present method of the invention is also suitable for gravel packing, or for fracturing and gravel packing in one operation (called, for example frac and pack, frac-n-pack, frac-pack, StimPac treatments, or other names), which are also used extensively to stimulate the production of hydrocarbons, water and other fluids from subterranean formations. These operations involve pumping a slurry of “proppant” (natural or synthetic materials that prop open a fracture after it is created) in hydraulic fracturing or “gravel” in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

Gravel is also a natural or synthetic material, which may be identical to, or different from, proppant. Gravel packing is used for “sand” control. Sand is the name given to any particulate material from the formation, such as clays, that could be carried into production equipment. Gravel packing is a sand-control method used to prevent production of formation sand, in which, for example a steel screen is placed in the wellbore and the surrounding annulus is packed with prepared gravel of a specific size designed to prevent the passage of formation sand that could foul subterranean or surface equipment and reduce flows. The primary objective of gravel packing is to stabilize the formation while causing minimal impairment to well productivity. Sometimes gravel packing is done without a screen. High permeability formations are frequently poorly consolidated, so that sand control is needed; they may also be damaged, so that fracturing is also needed. Therefore, hydraulic fracturing treatments in which short, wide fractures are wanted are often combined in a single continuous (“frac and pack”) operation with gravel packing. For simplicity, in the following we may refer to any one of hydraulic fracturing, fracturing and gravel packing in one operation (frac and pack), or gravel packing, and mean them all.

Any additives normally used in well treatment fluids can be included, again provided that they are compatible with the other components and the desired results of the treatment. Such additives can include, but are not limited to breakers, anti-oxidants, crosslinkers, corrosion inhibitors, delay agents, biocides, buffers, fluid loss additives, pH control agents, solid acids, solid acid precursors, etc. The wellbores treated can be vertical, deviated or horizontal. They can be completed with casing and perforations or open hole.

### Examples

A series of experiments were conducted to show embodiments according to the invention. In the experiments herewith three types of aluminum octoate were tested: (1) “di-ester”: CAS# 30745-55-2, hydroxyaluminium bis(2-ethylhexanoate) and (2) “tri-ester”: CAS# 3002-63-9, aluminum 2-ethylhexanoate, (3) aluminum triisopropanolate. The viscoelastic surfactant (VES) typically contained about 40% betaine unless otherwise indicated.

Several formulations of phosphorus-free gelled oil were studied. One formulation consists of diesel (red, low-sulfur), 6% of viscoelastic surfactant containing erucic amidopropyl dimethyl betaine, and 2.4% aluminum 2-ethylhexanoate (available from World Metal, LLC). The mixing was conducted in a typical 1 L Waring blender at about 70-80% full speed. The complete gelling typically occurred within 3-8 minutes. The gel appeared very viscous at room temperature, and formed a good “lip” when poured out of the blender cup. The viscosity at 100 deg C. (212 deg F.) of the gelled oil was then tested with a Fann50-type viscometer following the API RP 39 procedure.

When 6% of the viscoelastic surfactant alone was mixed in diesel without the aluminum 2-ethylhexanoate, no obvious increase in fluid viscosity was observed. This suggests that VES may not have formed inverse micelles in diesel. It is, therefore, reasonable to conclude that aluminum 2-ethylhexanoate renders the viscosity through crosslinking.

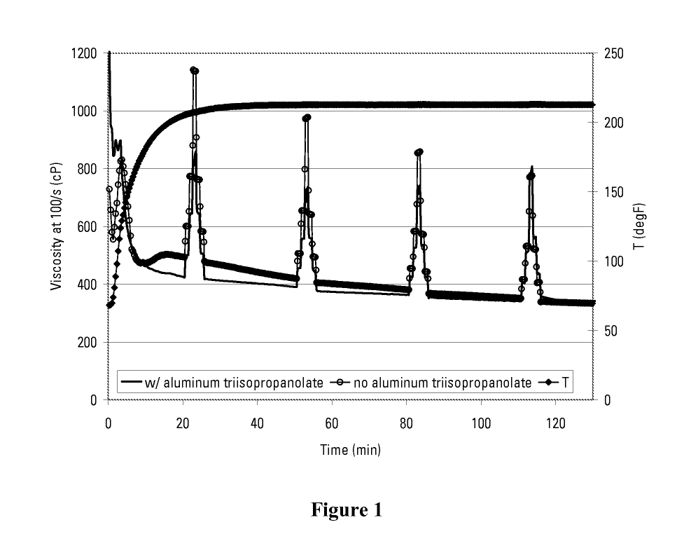

In another formulation, 0.24% aluminum triisopropanolate, a second aluminum component, was added to the aforementioned formulation. In FIG. 1, the viscosity at 100 deg C. (212 deg F.) is shown for the above two gel formulations. Both gels stayed above 300 cP at the shear rate of 100/s after 2 hours, and the addition of second aluminum compound did not seem to significantly enhance the gel property.

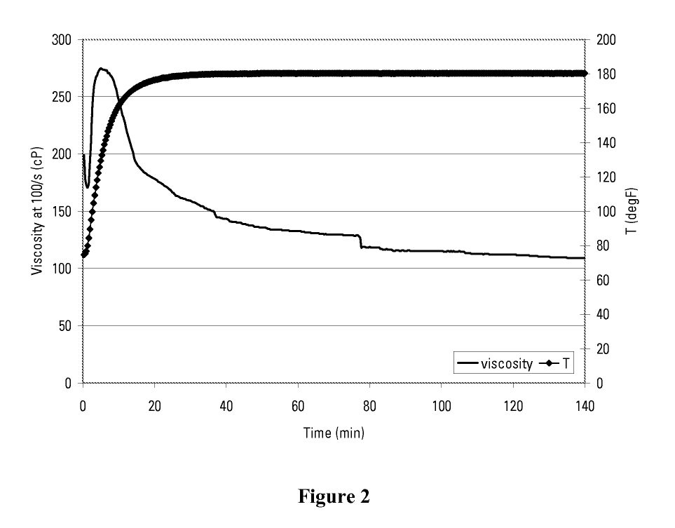

At lower temperatures, the concentration of the crosslinker can be reduced accordingly. In one gel formulation, diesel, 3% VES, and 1.2% (reduced from 2.4%) aluminum 2-ethylhexanoate were studied. Viscosity at 82.2 deg C. (180 deg F.) was tested with the Fann50-type viscometer. In FIG. 2, the viscosity of the gelled oil is shown. The gel stayed above 100 cP for at least 2 hours.

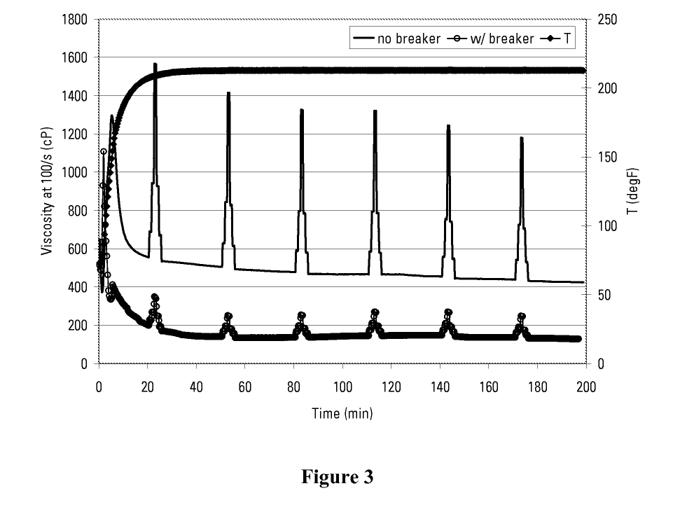

Breakers for the phosphorus-free gelled oil were evaluated. As viscoelastic surfactant containing erucic amidopropyl dimethyl betaine alone did not adequately viscosify (perhaps not forming inverse micelles) in diesel, in some cases the breakers for this phosphorus-free gelled oil should be selected to break aluminum bonds instead of breaking micelles. In one example, diesel, 3% viscoelastic surfactant containing erucic amidopropyl dimethyl betaine, and 2.4% aluminum 2-ethylhexanoate were similarly mixed to form a viscous gel at room temperature with a good “lip”. The viscosity at 100 deg C. (212 deg F.) of the gelled oil was then tested with a Fann50-type viscometer following the API RP 39 procedure. 0.6% ammonium bicarbonate (NH₄HCO₃) was added as the breaker into the above gel, and its viscosity was tested. In FIG. 3, the viscosity at 100 deg C. (212 deg F.) is shown for the two gels, one with the breaker, and the other without the breaker. The gel without the breaker stayed above 400 cP at the shear rate of 100/s after 3 hours, while the viscosity of the gel with the breaker dropped to about 130 cP after the same period of time.

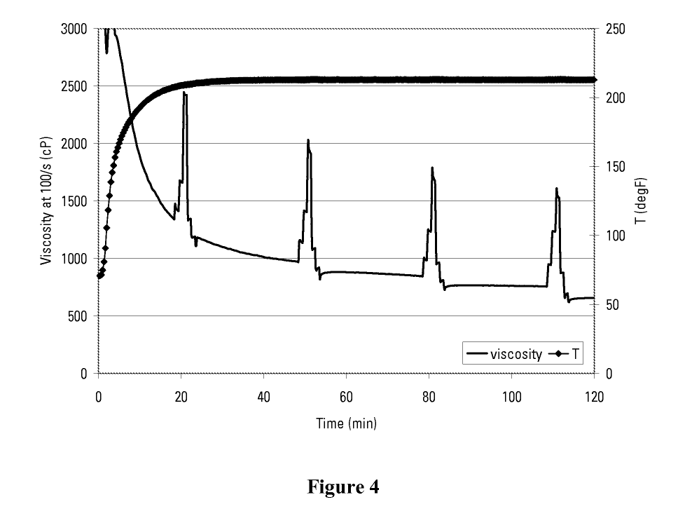

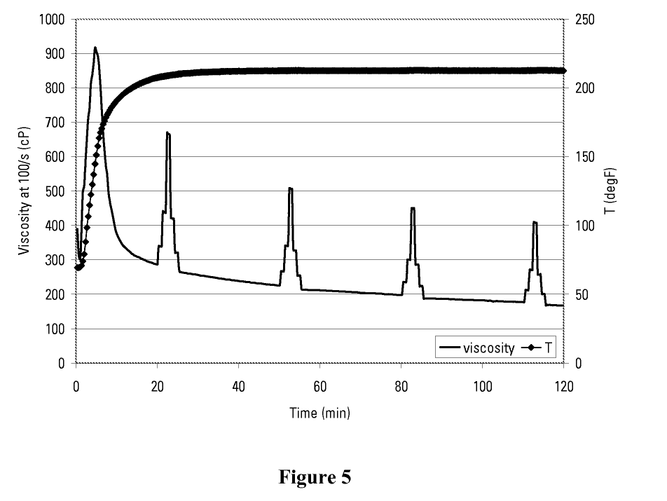

In FIG. 4, a gel formulation is shown consisting of diesel, 3% VES containing erucic amidopropyl dimethyl betaine, and 2.4% hydroxyaluminum bis(2-ethylhexanoate) (replacing aluminum 2-ethylhexanoate). Viscosity at 100 deg C. (212 deg F.) was tested with the Fann50-type viscometer. The gel stayed above 600 cP for at least 2 hours. In FIG. 5, a gel formulation is shown consisting of diesel, 3% VES containing about 30% oleoylamidopropyl dimethyl betaine, and 1.9% aluminum 2-ethylhexanoate. Viscosity at 100 deg C. (212 deg F.) was tested with the Fann50-type viscometer. The gel stayed above 150 cP for at least 2 hours.

It is clear that the present invention is well adapted to carry out its objectives and attain the ends and advantages mentioned above as well as those inherent therein. While presently embodiments of the invention have been described in varying detail for purposes of disclosure, it will be understood that numerous changes may be made which will readily suggest themselves to those skilled in the art and which are encompassed within the spirit of the invention disclosed and as defined in the written description and appended claims.

1. A method of forming a gelled organic-based fluid, comprising:
a. combining an organic solvent, a viscoelastic surfactant, and a metal carboxylate crosslinker; and
b. forming the gelled organic-based fluid.

2. The method of claim 1, wherein the organic solvent is selected from the group consisting of diesel oil, kerosene, paraffinic oil, crude oil, refined oil, gas-condensates, LPG, toluene, xylene, ethers, esters, mineral oil, biodiesel, vegetable oil, animal oil, alcohol, and mixtures thereof.

3. The method of claim 1, wherein the viscoelastic surfactant comprises a betaine compound selected from the group consisting of erucic amidopropyl dimethyl betaine, oleoylamidopropyl dimethyl betaine, cocamidopropyl betaine, and mixtures thereof.

4. The method of claim 1, wherein the metal carboxylate crosslinker is branched and each carboxylate branch has from about 6 to about 30 carbon atoms.

5. The method of claim 4, wherein the metal carboxylate crosslinker is selected from the group consisting of: di-ester with the same branched carboxylic acid, tri-ester with the same branched carboxylic acid and mixtures thereof.

6. The method of claim 1, wherein the metal carboxylate crosslinker is an aluminum carboxylate crosslinker.

7. The method of claim 6, wherein the aluminum carboxylate crosslinker is selected from group consisting of aluminum 2-ethylhexanoate, hydroxyaluminum bis(2-ethylhexanoate), and mixtures thereof.

8. The method of claim 1, wherein the gelled organic-based fluid further comprises a breaker.

9. The method of claim 8, wherein the breaker is encapsulated.

10. The method of claim 8, wherein the breaker is a bicarbonate, urea or modified urea.

11. The method of claim 1, wherein the gelled organic-based fluid is foamed.

12. The method of claim 1, wherein forming the gelled organic-based fluid does not comprise addition of a phosphorus source.

13. The method of claim 1, wherein forming the gelled organic-based fluid does not comprise addition of an aliphatic monocarboxylic acid.

14. A method of treating a subterranean formation from a well, comprising:
a. providing an organic solvent, a viscoelastic surfactant, and a metal carboxylate crosslinker;
b. combining the organic solvent, the viscoelastic surfactant and the metal carboxylate crosslinker to form a gelled organic-based fluid;
c. introducing the gelled organic-based fluid in to the well; and
d. allowing the gelled organic-based fluid to contact the formation.

15. The method of claim 14, comprising fracturing step, and introducing the gelled organic-based fluid in to the well is done at a pressure above a fracturing pressure of the subterranean formation.

16. The method of claim 14, further comprising:
e. introducing proppant in to the well.

17. The method of claim 14, wherein treating the subterranean formation with the gelled organic-based fluid does not comprise providing a phosphorus source for treating the subterranean formation.

18. The method of claim 14, wherein forming the gelled organic-based fluid is done without addition of an aliphatic monocarboxylic acid.

19. The method of claim 14, wherein the organic solvent is selected from the group consisting of diesel oil, kerosene, paraffinic oil, crude oil, refined oil, gas-condensates, LPG, toluene, xylene, ethers, esters, mineral oil, biodiesel, vegetable oil, animal oil, alcohol, and mixtures thereof.

20. The method of claim 14, wherein the viscoelastic surfactant comprises a betaine compound selected from the group consisting of erucic amidopropyl dimethyl betaine, oleoylamidopropyl dimethyl betaine, cocamidopropyl betaine, and mixtures thereof.

21. The method of claim 14, wherein the metal carboxylate crosslinker is branched and each carboxylate branch has from about 6 to about 30 carbon atoms.

22. The method of claim 21, wherein the metal carboxylate crosslinker is selected from the group consisting of: di-ester with the same branched carboxylic acid, tri-ester with the same branched carboxylic acid and mixtures thereof.

23. The method of claim 14, wherein the metal carboxylate crosslinker is an aluminum carboxylate crosslinker.

24. The method of claim 23, wherein the aluminum carboxylate crosslinker is selected from group consisting of aluminum 2-ethylhexanoate, hydroxyaluminum bis(2-ethylhexanoate), and mixtures thereof.

25. The method of claim 14, the gelled organic-based fluid further comprises a breaker.

26. The method of claim 25, wherein the breaker is encapsulated.

27. The method of claim 25, wherein the breaker is a bicarbonate, urea or modified urea.

28. A method of treating a well or a pipeline, comprising:
a. providing an organic solvent, a viscoelastic surfactant, and a metal carboxylate crosslinker;
b. combining the organic solvent, the viscoelastic surfactant and the metal carboxylate crosslinker to form a gelled organic-based fluid; and
c. introducing the gelled organic-based fluid in to the well or in to the pipeline.

29. The method of claim 28, wherein treating the well is selected from the group consisting of: cleanout of the well, cleanout of the pipeline, scale removal of the well, scale removal of the pipeline, solid removal of the well, solid removal of the pipeline, assisting solid transport of the well, assisting solid transport of the pipeline, assisting paraffin transport of the well, assisting paraffin transport of the pipeline, assisting asphaltene transport of the well, assisting asphaltene transport of the pipeline, fluid loss control of the well, fluid diversion of the well, and combinations thereof.

30. The method of claim 28, wherein forming the gelled organic-based fluid does not comprise addition of a phosphorus source.
